(19) United States
(12) Patent Application Publication
(10) Pub. No.: US 2017/0003008 A1
(43) Pub. Date: Jan. 5, 2017

(54) LIGHTING EQUIPMENT

(71) Applicant: Hideaki Ito, Maebashi-shi (JP)

(72) Inventor: Hideaki Ito, Maebashi-shi (JP)

(21) Appl. No.: 14/858,429

(22) Filed: Sep. 18, 2015

(30) Foreign Application Priority Data
Jul. 3, 2015 (JP) 2015-134463

(51) Int. Cl. F21V 21/30; F21V 33/00; F21V 21/15; F21V 21/22

(52) U.S. Cl. CPC F21V 21/30; F21V 21/22; F21V 33/0064; F21V 21/15; F21W 2131/1005

(57) ABSTRACT

[Object] To provide lighting equipment including illuminating lamps that automatically turn outward in a state where the lighting equipment is at an elevation angle of −90° at which the light irradiation direction is directed directly downward.

[Solution Means] In this lighting equipment 100, when the illuminating portion 90 is at a directly downward illuminating position with an elevation angle of −90°, illuminating lamps 20a to 20b′ automatically turn outward. Accordingly, a worksite can be widely illuminated. In the region in which the elevation angle of the illuminating portion 90 is a predetermined angle or more, the elevation angles of the illuminating lamps 20a to 20b′ are maintained at substantially 0°, and the normal direction of the illuminating portion 90 substantially matches the irradiation directions of the illuminating lamps 20a to 20b′. Accordingly, the illuminating portion 90 can illuminate a distant object with a high illuminance. The elevation angles of the illuminating lamps 20a to 20b′ are varied and maintained by the link mechanisms 50 by mechanically interlocking with pivoting of the illuminating arm portions 40 and 40′.

### TECHNICAL FIELD

The present invention relates to lighting equipment to be used mainly at an outdoor construction site and for rescue operations, etc.

### BACKGROUND ART

At a construction site, during relief and rescue operations, and firefighting, etc., at night, lighting equipment that illuminates a worksite is essential. The degree of freedom of the light irradiation direction of lighting equipment to be used for these activities is preferably as high as possible. In this regard, the inventors of the present application developed an invention relating to a variable direction type support device described in [Patent Document 1] listed below which can freely change the irradiation direction of illumination upward, downward, rightward, and leftward by installing lighting equipment thereon. In addition, the inventors developed an invention described in [Japanese Patent Application No. 2014-97454] relating to a raising and lowering device with illumination capable of changing the irradiation direction of illumination upward, downward, rightward, and leftward.

### CITATION LIST

### Patent Document

[Patent Document 1] Japanese Published Examined Patent Application No. 5433613

### SUMMARY OF THE INVENTION

### Problem to be Solved by the Invention

For further improvement in light amount of lighting equipment, use of multi-lamp lighting equipment with multiple illuminating lamps is desirable. The irradiation directions of the illuminating lamps of such multi-lamp lighting equipment are generally set to the same direction to irradiate a number of lights toward a distant object. However, there is a problem that with this lighting equipment, when the light irradiation direction is directed directly downward to illuminate a worksite, only the area directly below the lighting equipment is illuminated, and the worksite cannot be widely illuminated.

The present invention was developed in view of the circumstances described above, and an object thereof is to provide lighting equipment with illuminating lamps that automatically turn outward in a state where the lighting equipment is at an elevation angle of −90° at which the light irradiation direction is directed directly downward.

### Means for Solving the Problem

The present invention solves the above-described problem by providing:

(1) Lighting equipment 100 including an illuminating portion 90 with four illuminating lamps 20a, 20b, 20a′, and 20b′ the elevation angles of which are variable, wherein
when the illuminating portion 90 is at an elevation angle of −90° at which the illuminating portion 90 is directed directly downward, the illuminating lamps 20a to 20b′ turn outward at a predetermined elevation angle θ with respect to the direction of the illuminating portion 90, and the elevation angles of the illuminating lamps 20a to 20b′ increase or decrease in the range of θ to 0° in inverse proportion to an increase or decrease in elevation angle of the illuminating portion 90 until the elevation angles of the illuminating portion 90 reach a predetermined angle, and when the elevation angle of the illuminating portion 90 is a predetermined angle or more, the elevation angles of the illuminating lamps 20a to 20b′ are maintained at substantially 0° and the normal direction of the illuminating portion 90 substantially matches the irradiation directions of the illuminating lamps 20a to 20b′.
   (2) The lighting equipment 100 according to (1) described above, wherein
the illuminating portion 90 includes
a base portion 30 rotatable in the horizontal direction,
illuminating arm portions 40 and 40′ that are mounted one each on the two side surfaces opposed to each other of the base portion 30, rotate coaxially right and left, and have both end faces 40a, 40b, 40a′, and 40b′ being at approximately 45° to their long-side directions,
illuminating lamps 20a to 20b′ mounted on both end faces 40a to 40b′ of the illuminating arm portions 40 and 40′ so that their elevation angles are variable,
link mechanisms 50 provided one each for the illuminating arm portions 40 and 40′ and vary the elevation angles of both illuminating lamps 20a to 20b′ mounted on both end faces 40a to 40b′ of the illuminating arm portions 40 and 40′, wherein
the elevation angles of the illuminating lamps 20a to 20b′ vary by mechanically interlocking with rotations of the illuminating arm portions 40 and 40′.
   (3) The lighting equipment 100 according to (2) described above, wherein
one link mechanism 50 includes
a rotary cylinder (first rotary cylinder 84, second rotary cylinder 84′) that rotates the illuminating arm portion 40, 40′,
a fixed shaft 82 coaxial with the rotary cylinder,
a fixed link plate 52 that is fixed to the fixed shaft 82 and has an arm 52a with a predetermined length,
a first link 54 one end of which is connected to the arm 52a of the fixed link plate 52,
a three-point plate 60 one point of which is axially supported rotatably on the illuminating arm portion 40, 40′, to another point of which the other end of the first link 54 is connected, and to the other one point of which a second link 55a and a third link 55b are connected,
a second link 55a the other end of which extends toward one end face 40a, 40a′ of the illuminating arm portion 40, 40′,
a third link 55b the other end of which extends toward the other end face 40b, 40b′ of the illuminating arm portion 40, 40′,
a first link plate 62a that is mounted rotatably on the one end face 40a, 40a′, and connected to the other end of the second link 55a,
a second link plate 62b that is mounted rotatably on the other end face 40b, 40b′, and connected to the other end of the third link 55b,
a first tilt bar 64a that rotates together with the first link plate 62a and has an arm with a predetermined length,
a second tilt bar 64b that rotates together with the second link plate 62b and has an arm with a predetermined length,
a first tilt link 56a one end of which is connected to the arm of the first tilt bar 64a,
a second tilt link 56b one end of which is connected to the arm of the second tilt bar 64b,
a first tilt stay 66a that is fixed to the illuminating lamp 20a, 20a′ mounted on one end face 40a, 40a′ of the illuminating arm portion 40, 40′ and bent into a substantially L-shape the tip end portion of which is connected to the other end of the first tilt link 56a, and
a second tilt stay 66b that is fixed to the illuminating lamp 20b, 20b′ mounted on the other end face 40b, 40b′ of the illuminating arm portion 40, 40′ and bent into a substantially L-shape the tip end portion of which is connected to the other end of the second tilt link 56b, wherein
according to rotations of the illuminating arm portions 40 and 40′, the three-point plates 60 rotate, the second links 55a and the third links 55b connected to the three-point plates 60 move in substantially the same direction, the first link plates 62a and the second link plates 62b rotate respectively and push and pull the tip sides bent into substantially L-shapes of the first tilt stays 66a and the second tilt stays 66b to vary the elevation angles of the illuminating lamps 20a to 20b′ on both end faces 40a to 40b′ by equal amounts, respectively.
   (4) The lighting equipment 100 according to (3) described above, wherein
a vertical fixed shaft 14 coaxial with the rotation axis in the horizontal direction of the base portion 30 and the fixed shaft 82 of the illuminating arm portions 40 and 40′ are joined in a T-shape, and
the rotary shaft portion 80 of the illuminating arm portions 40 and 40′ includes a first rotary cylinder 84 that is connected to one illuminating arm portion 40 and inserted on the fixed shaft 82, a second rotary cylinder 84′ that is connected to the other illuminating arm portion 40′ and inserted on the fixed shaft 82, and a connecting bar 86 that joins the first rotary cylinder 84 and the second rotary cylinder 84′, where
the connecting bar 86 is fixed to circumferential surfaces of portions of the first rotary cylinder 84 and the second rotary cylinder 84′, and
further includes
a tilt limiting means that limits the rotation ranges of the first rotary cylinder 84 and the second rotary cylinder 84′ to prevent the connecting bar 86 from coming into contact with the vertical fixed shaft 14.

### Effect of the Invention

Lighting equipment according to the present invention has illuminating lamps that automatically turn outward when the lighting equipment is at a directly downward illuminating position with an elevation angle of −90° at which the light irradiation direction is directed directly downward. Therefore, a worksite can be widely illuminated without special operations.

### BRIEF DESCRIPTION OF THE DRAWINGS

FIG. 1 is a front view of lighting equipment according to the present invention.

FIG. 2 is a perspective view of the lighting equipment according to the present invention when it is at a directly downward illuminating position.

FIGS. 3(a) and 3(b) are schematic views showing the interior of the base portion of the lighting equipment according to the present invention.

FIG. 4 is a schematic configuration diagram of a link mechanism viewed from immediately below of the lighting equipment according to the present invention when it is at the directly downward illuminating position.

FIG. 5 is a schematic configuration diagram of the link mechanism of the lighting equipment according to the present invention when it is at the directly downward illuminating position.

FIG. 6 is a schematic configuration diagram of the link mechanism of the lighting equipment according to the present invention when the lighting equipment is at an elevation angle of −45°.

FIG. 7 is a schematic configuration diagram of the link mechanism of the lighting equipment according to the present invention when the lighting equipment is at an elevation angle of 0°.

FIGS. 8(a) and 8(b) are partial enlarged views of the link mechanism of the lighting equipment according to the present invention.

FIG. 9 shows illuminance distribution simulation results of the lighting equipment according to the present invention.

### BEST MODE FOR CARRYING OUT THE INVENTION

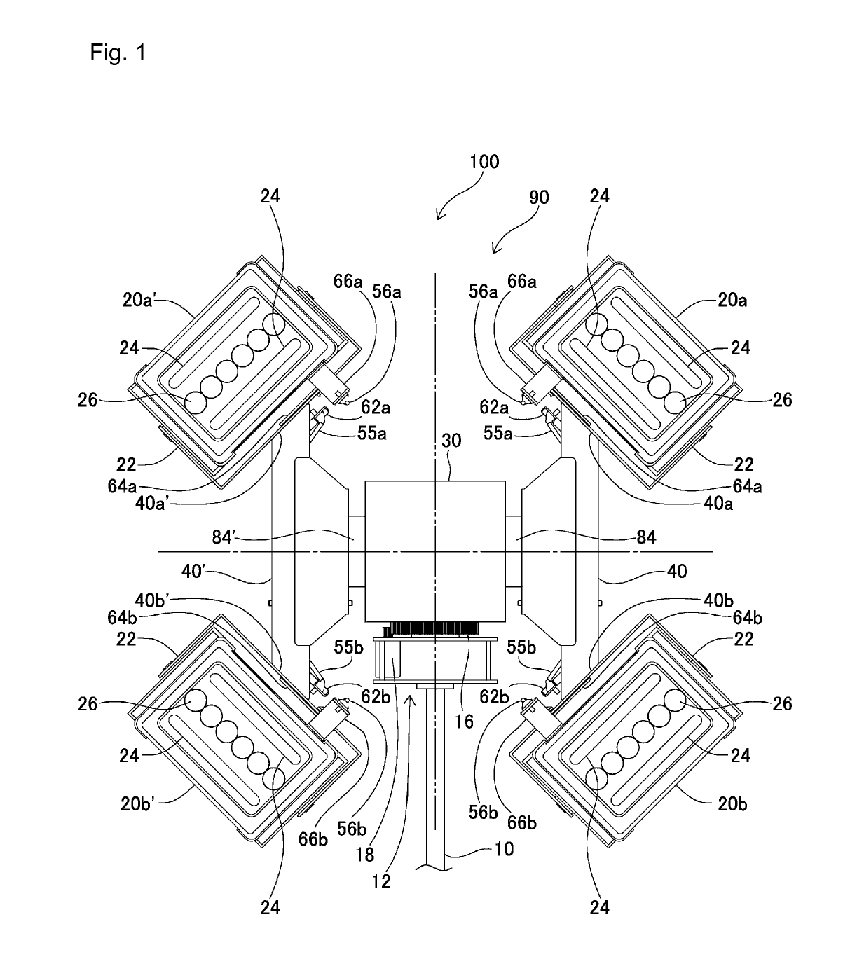

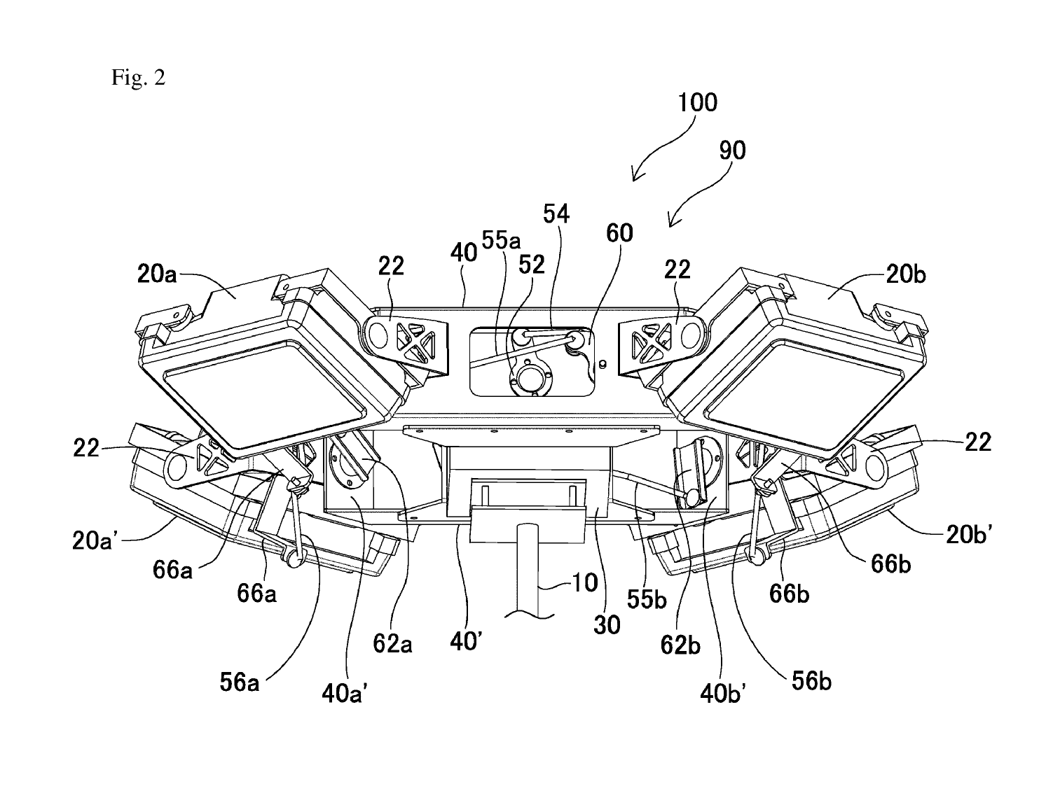

An embodiment of lighting equipment 100 according to the present invention is described based on the drawings. Here, FIG. 1 is a front view of the lighting equipment 100 according to the present invention when an illuminating portion 90 is at an elevation angle of 0° (directed toward the horizontal direction). FIG. 2 is a perspective view when the illuminating portion 90 of the lighting equipment 100 according to the present invention is at an elevation angle of −90° (directly downward illuminating position at which the illuminating portion 90 is directed directly downward). The lighting equipment 100 according to the present invention is assumed to be installed on a special-purpose vehicle such as a fire truck and work by obtaining power from the vehicle. However, the vehicle on which the lighting equipment is installed is not limited to this, and the lighting equipment may be installed on a construction vehicle or other vehicles. In addition, the lighting equipment may also be mounted on a cart or base, etc., and used.

First, the lighting equipment 100 according to the present invention includes an illuminating portion 90 and a post portion 10. The illuminating portion 90 includes a base portion 30 connected to the post portion 10, illuminating arm portions 40 and 40′ mounted one each on the two side surfaces opposed to each other of the base portion 30, illuminating lamps 20a, 20b, 20a′, and 20b′ mounted on the respective end faces 40a, 40b, 40a′ and 40b′ of the illuminating arm portions 40 and 40′ so that their elevation angles are variable, and link mechanisms 50 that are provided one each for the illuminating arm portions 40 and 40′ to vary the elevation angles of the illuminating lamps 20a to 20b′. The link mechanisms 50 are described in detail later. The end faces 40a to 40b′ of the illuminating arm portions 40 and 40′ are at angles of substantially 45° to the long-side directions of the illuminating arm portions 40 and 40′, and the illuminating lamps 20a to 20b′ are mounted via illuminating lamp stays 22 fixed to the end faces 40a to 40b′, respectively. Further, the lighting equipment 100 includes a rotation mechanism 12 that rotates the illuminating portion 90 in the horizontal direction (direction horizontal with respect to the post portion 10). In this example, the rotation mechanism 12 is provided at the connecting portion between the post portion 10 and the base portion 30, however, the configuration of the rotation mechanism 12 is not especially limited to this.

The post portion 10 holds the illuminating portion 90 at a predetermined height, a post portion that is manually or electrically raised and lowered is preferably used, and it is particularly preferable that the post portion 10 is formed into a pipe and cables to be connected to the respective portions of the illuminating portion 90 are inserted inside the pipe and connected to an operation panel and a power supply located below.

The four illuminating lamps 20a, 20b, 20a′, and 20b′ are preferably disposed radially at even intervals, and therefore, right and left illuminating arm portions 40 and 40′ are formed so that the illuminating lamps 20a to 20b′ are positioned symmetrically to each other with respect to both of the axis shown by the alternate long and short dash line and the axis shown by the alternate long and short two dashes line in FIG. 1.

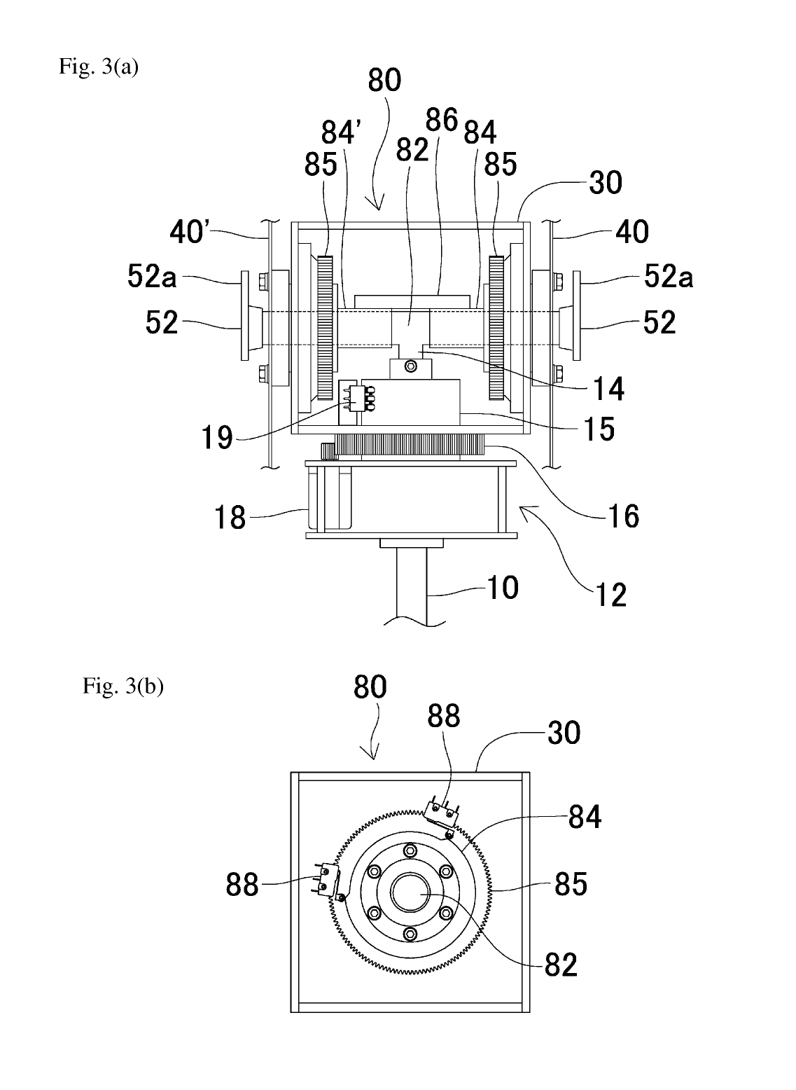

Next, an example of the preferable rotation mechanism 12 of the lighting equipment 100 is described with reference to FIG. 3(a). FIG. 3(a) is a schematic view showing the interior of the base portion 30. The rotation mechanism 12 preferable for the lighting equipment 100 shown in FIG. 3(a) includes a horizontal rotary gear 16 fixed to the bottom surface of the base portion 30, and a horizontal rotary motor 18 connected to the horizontal rotary gear 16. When a user performs an operation to pan the lighting equipment 100 by using the operation panel, etc., the horizontal rotary motor 18 rotates, and according to this, the horizontal rotary gear 16 rotates and the base portion 30 rotates together with the illuminating arm portions 40 and 40′. Accordingly, the illuminating portion 90 rotates in the horizontal direction, and the lighting equipment 100 pans. The rotation mechanism 12 may be provided with a horizontal direction detection means that detects the irradiation direction of the illuminating portion 90 (direction of the base portion 30). With this configuration, according to signals from the horizontal direction detection means, the rotation range of the illuminating portion 90 can be limited and the illuminating portion 90 can be automatically positioned in a specific direction set in advance. Here, a preferable example of the horizontal direction detection means is shown. A preferable horizontal direction detection means of the lighting equipment 100 according to the present invention includes a fixed cylinder 15 that is fixed to the post portion 10 side and has a mark such as a concavity or convexity marked at a predetermined position on the circumferential surface, and a pan sensor 19 that comes into sliding contact with the circumferential surface of the fixed cylinder 15. When the base portion 30 is rotated by the horizontal rotary motor 18, the pan sensor 19 rotates and moves along the circumferential surface of the fixed cylinder 15 and detects the mark on the circumferential surface of the fixed cylinder 15. Then, according to a signal from this pan sensor 19, the direction of the illuminating portion 90 is recognized, and predetermined pan control is performed for the illuminating portion 90.

Next, a preferable example of the rotary shaft portion 80 that rotates the illuminating arm portions 40 and 40′ is described. First, in the base portion 30, a fixed shaft 82 that penetrates two side surfaces opposed to each other is provided. On this fixed shaft 82, a first rotary cylinder 84 connected to one illuminating arm portion 40 and a second rotary cylinder 84′ connected to the other illuminating arm portion 40′ are inserted movably. Circumferential surfaces of portions of the first rotary cylinder 84 and the second rotary cylinder 84′ are fixed by a connecting bar 86, and by this connecting bar 86, the first rotary cylinder 84 and the second rotary cylinder 84′ are joined. The fixed shaft 82 is partially exposed between the first rotary cylinder 84 and the second rotary cylinder 84′. The rotary shaft portion 80 is provided with a vertical fixed shaft 14 coaxial with the horizontal rotary gear 16, that is, coaxial with the rotation axis in the horizontal direction of the base portion 30, and this vertical fixed shaft 14 and the fixed shaft 82 are joined in a T-shape at the exposed portion between the first rotary cylinder 84 and the second rotary cylinder 84′. Thus, by joining the vertical fixed shaft 14 in the vertical direction and the fixed shaft 82 in the horizontal direction in a T-shape, torsion and eccentricity are suppressed at the time of pivoting of the illuminating arm portions 40 and 40′ and panning of the illuminating portion 90, and rotating operations of the respective portions of the illuminating portion 90 can be smoothly performed.

For each of the first rotary cylinder 84 and the second rotary cylinder 84′, a rotary gear 85 is formed, and to this rotary gear 85, a tilt motor (not shown) is connected. When tilt motors rotate, the rotary gears 85 rotate, and accordingly, the first rotary cylinder 84 and the second rotary cylinder 84′ rotate and the illuminating arm portions 40 and 40′ pivot with the same phase in the same direction. At this time, the fixed shaft 82 inserted in the first rotary cylinder 84 and the second rotary cylinder 84′ does not rotate.

In the case where the vertical fixed shaft 14 and the fixed shaft 82 are joined in a T-shape, there is a possibility that the connecting bar 86 collides with the vertical fixed shaft 14 due to rotations of the first rotary cylinder 84 and the second rotary cylinder 84′. Therefore, it is preferable that the first rotary cylinder 84 or the second rotary cylinder 84′ is provided with a tilt limiting means that limits the rotation ranges of the first rotary cylinder 84 and the second rotary cylinder 84′. This tilt limiting means has, for example, as shown in FIG. 3(b), a configuration in which a mark such as a step, a concavity or convexity, etc., is provided at a predetermined position on the circumferential surface of the first rotary cylinder 84 or the second rotary cylinder 84′, a detecting member 88 that detects this mark is provided, and the rotation ranges of the first rotary cylinder 84 and the second rotary cylinder 84′ are limited according to a signal from this detecting member 88.

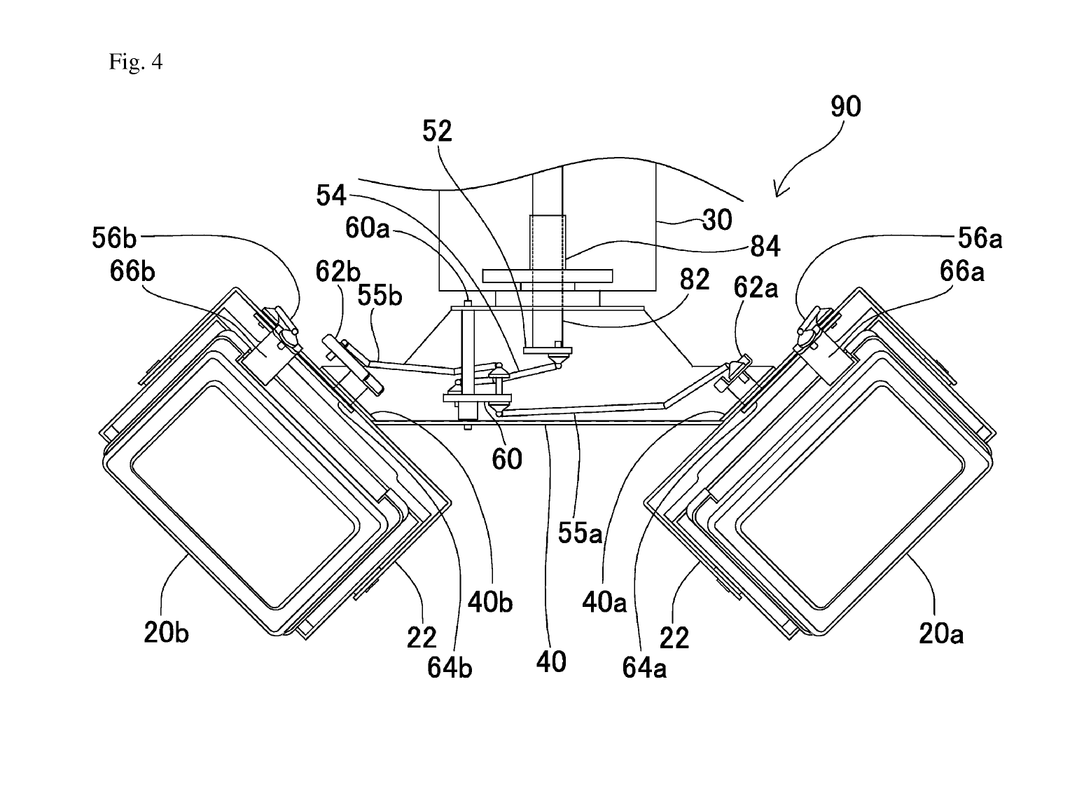

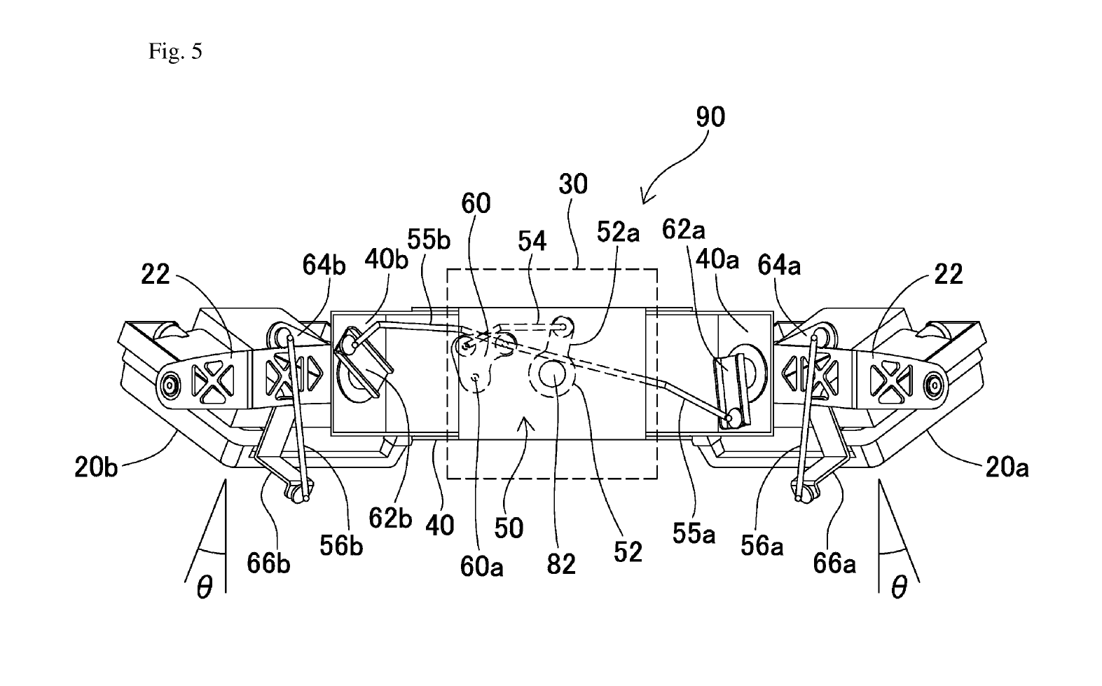

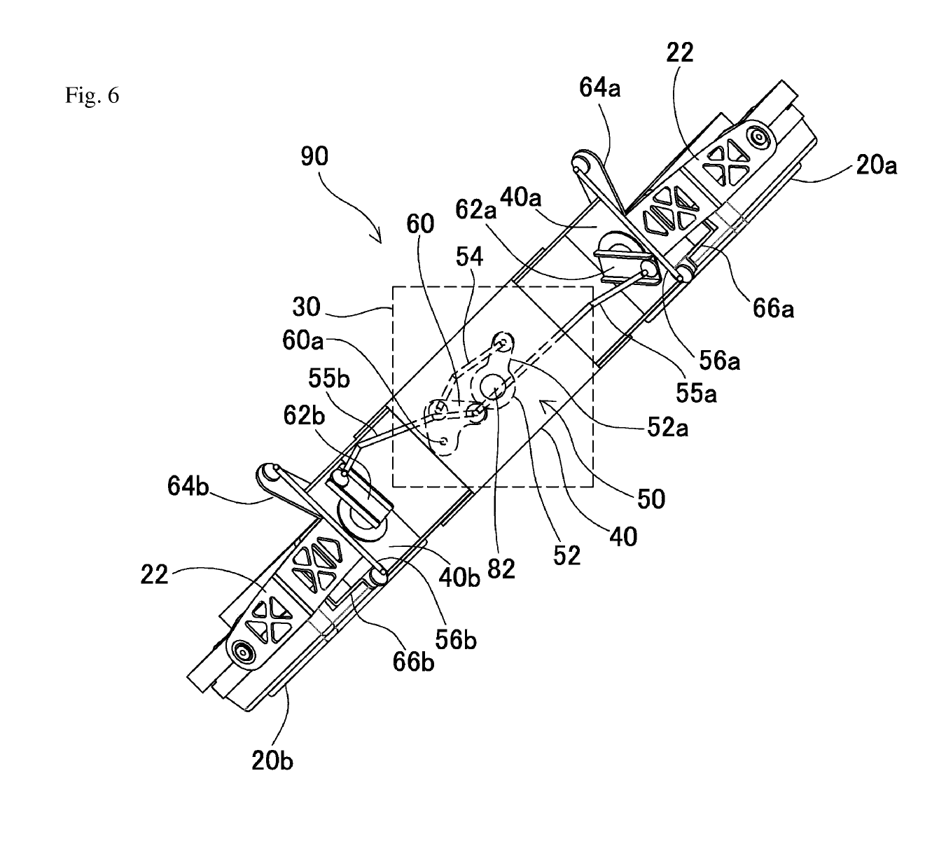

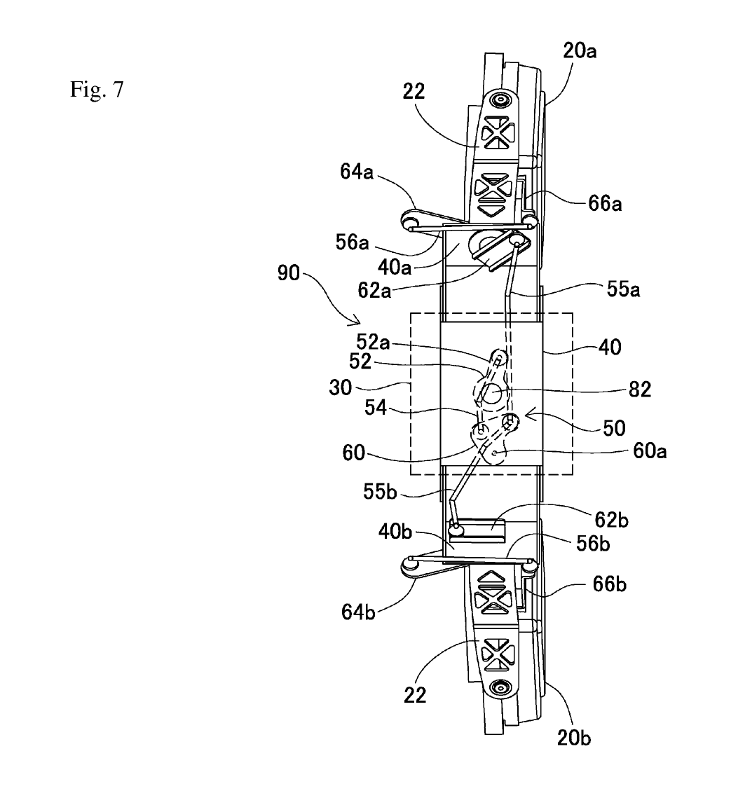

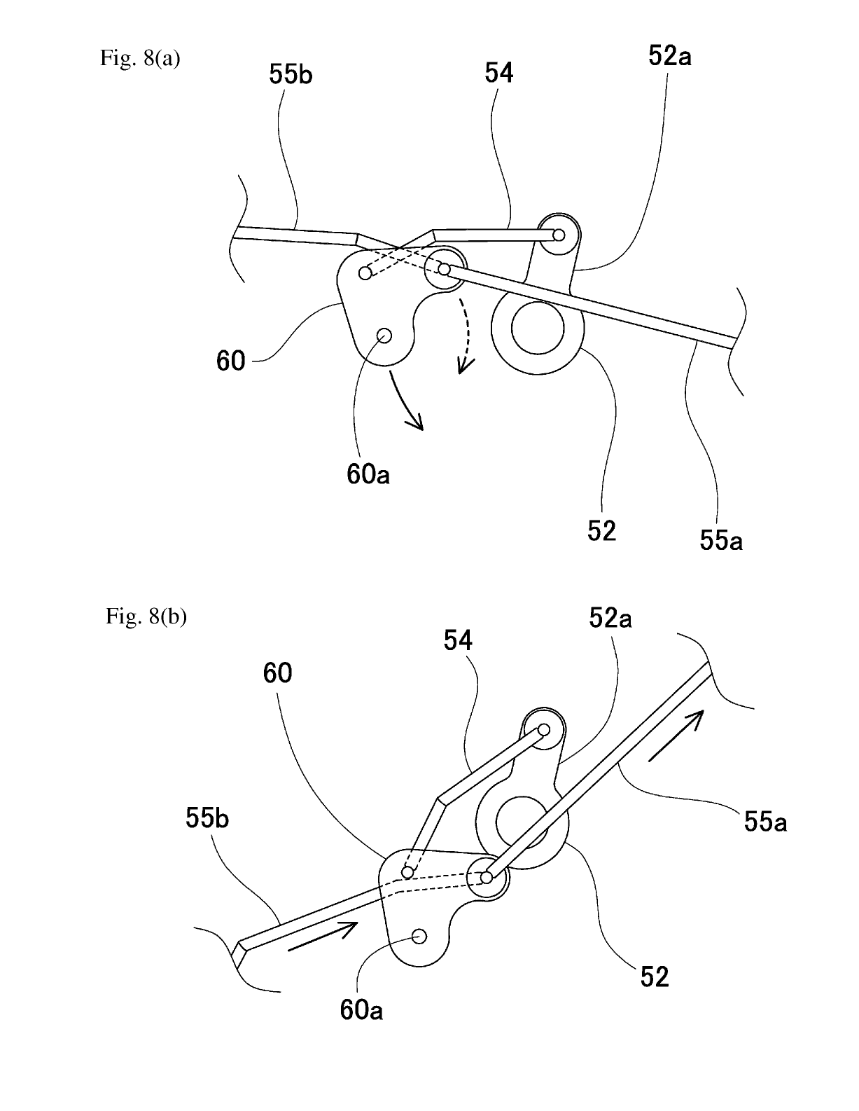

Next, the configuration and operation of the link mechanism 50 of the lighting equipment 100 is described with reference to FIG. 4 to FIG. 8. Here, FIG. 4 is a schematic configuration diagram of the link mechanism 50 of one illuminating arm portion 40 viewed from immediately below when it is at the directly downward illuminating position. FIG. 5 is a schematic configuration diagram of the link mechanism 50 viewed from the base portion 30 side when it is at the directly downward illuminating position. FIG. 6 is a schematic configuration diagram of the link mechanism 50 viewed from the base portion 30 side when the illuminating portion 90 is at an elevation angle of −45°. FIG. 7 is a schematic configuration diagram of the link mechanism 50 viewed from the base portion 30 side when the illuminating portion 90 is at an elevation angle of 0° (directed toward the horizontal direction). FIG. 8 are partial enlarged views of the link mechanisms 50 shown in FIG. 5 and FIG. 6. The link mechanism 50 of the illuminating arm portion 40 and the link mechanism 50 of the illuminating arm portion 40′ are configured symmetrically to each other, and their operations are the same. Here, the configuration and operation of one illuminating arm portion 40 is described.

First, as shown in FIG. 4, to one illuminating arm portion 40, the first rotary cylinder 84 that rotates around the fixed shaft 82 is fixed. According to rotation of the first rotary cylinder 84, the illuminating arm portion 40 pivots around the fixed shaft 82. The fixed shaft 82 is inserted in the illuminating arm portion 40, and as shown in FIG. 4 to FIG. 7, fixed to a fixed link plate 52 having an arm 52a with a predetermined length. Therefore, the direction of the fixed link plate 52 and the arm 52a is always constant and does not change regardless of pivoting of the illuminating arm portion 40. To the arm 52a of the fixed link plate 52, one end of a first link 54 with a predetermined length is connected movably. Both ends of the first link 54 and a second link 55a, a third link 55b, a first tilt link 56a, and a second tilt link 56b which are described later are connected respectively by, for example, ball joints, etc., that can move three-dimensionally. Further, the link mechanism 50 has a three-point plate 60 one point of which is axially supported on the illuminating arm portion 40 by a shaft pin 60a. To another point of the three-point plate 60, the other end of the first link 54 is connected. To the other one point of the three-point plate 60, one end of the second link 55a extending toward one end face 40a and one end of the third link 55b extending toward the other end face 40b are connected. To avoid contact between the second link 55a and the third link 55b, it is preferable that, as shown in FIG. 4, they are connected to the front surface side and back surface side of the three-point plate 60, respectively, and bent at a predetermined angle to excellently transmit the rotation of the three-point plate 60 to the first link plate 62a and the second link plate 62b.

The other end of the second link 55a is connected to the arm of the first link plate 62a mounted rotatably on one end face 40a of the illuminating arm portion 40. The other end of the third link 55b is connected to the arm of the second link plate 62b mounted rotatably on the other end face 40b of the illuminating arm portion 40. To the first link plate 62a, the first tilt bar 64a that rotates together with the first link plate 62a and has an arm with a predetermined length is fixed. To the second link plate 62b, the second tilt bar 64b that rotates together with the second link plate 62b and has an arm with a predetermined length is fixed. To the bottom surface of the illuminating lamp 20a, the first tilt stay 66a the front surface side of which is bent into a substantially L-shape toward the base portion 30 side is fixed, and the tip side of the bent first tilt stay 66a and the tip side of the arm of the first tilt bar 64a are joined by the first tilt link 56a. To the bottom surface of the illuminating lamp 20b, the second tilt stay 66b the front surface side of which is bent into a substantially L-shape toward the base portion 30 side is fixed, and the tip side of the bent second tilt stay 66b and the tip side of the arm of the second tilt bar 64b are joined by the second tilt link 56b.

Lengths and angles, etc., of these components of the link mechanisms 50 are appropriately designed to optimum values according to the dimensions of the respective portions constituting the illuminating portion 90 and the value of the elevation angle θ required for the illuminating lamps 20a to 20b′, etc. However, the first tilt bar 64a, the first tilt link 56a, and the first tilt stay 66a, and the second tilt bar 64b, the second tilt link 56b, and the second tilt stay 66b are configured so as to become axisymmetric to each other with respect to the axis of the fixed shaft 82. On the other hand, the angle between the first link plate 62a and the first tilt bar 64a and the angle between the second link plate 62b and the second tilt bar 64b are individually set to appropriate angles. The phase difference between the first link plate 62a and the second link plate 62b is approximately 120°, and when the second link 55a and the third link 55b are moved by the three-point plate 60, the first link plate 62a and the second link plate 62b connected to these links rotate in directions opposite to each other.

Next, operation of the link mechanism 50 is described. First, when the illuminating portion is at the directly downward illuminating position shown in FIG. 5, the tip ends of the arms of the first tilt bar 64a and the second tilt bar 64b are positioned in the very front side. Accordingly, the tip sides of the first tilt stay 66a and the second tilt stay 66b bent into L-shapes are pressed forward via the first tilt link 56a and the second tilt link 56b, and the illuminating lamps 20a and 20b turn outward around the holding shafts of the illuminating lamp stays 22. At this time, the elevation angle θ of the illuminating lamps 20a and 20b with respect to the direction of the illuminating portion 90 is preferably 20° to 40°, and most preferably 30°.

Next, when the elevation angle of the illuminating portion 90 is increased from the state at the directly downward illuminating position shown in FIG. 5 to the state shown in FIG. 6 or FIG. 7, a user performs a tilting operation by using the operation panel, etc. Accordingly, the tilt motors inside the base portion 30 rotate, and via the rotary gears 85, the first rotary cylinder 84 and the second rotary cylinder 84′ rotate. When the first rotary cylinder 84 rotates, the illuminating arm portions 40 and 40′ fixed to the first rotary cylinder 84 and the second rotary cylinder 84′ pivot in a direction to increase the elevation angle of the illuminating portion 90 (counterclockwise in FIG. 5 to FIG. 7) around the fixed shaft 82. At this time, the fixed link plates 52 fixed to the fixed shaft 82 do not change regardless of the rotating operation of the illuminating arm portions 40 and 40′ as shown in FIG. 8(a) and FIG. 8(b). However, the three-point plates 60 mounted on the illuminating arm portions 40 and 40′ revolve around the fixed shaft 82 according to rotation of the illuminating arm portions 40 and 40′ as shown by the solid arrow in FIG. 8(a). At this time, the rotation of the three-point plate 60 is limited by the first link 54 connected to the fixed link plate 52, and as a result, the three-point plate 60 spins in the direction shown by the dashed-line arrow in FIG. 8(a) around the shaft pin 60a while revolving around the fixed shaft 82. When the illuminating portion is at a position near the directly downward illuminating position, the arm 52a of the fixed link plate 52 is in a direction substantially perpendicular to the lines between the shaft pin 60a and the fixed shaft 82, and in this region, the displacement amounts of the arm 52a and the three-point plate 60 are comparatively large. According to turning of the three-point plate 60, both of the second link 55a and the third link 55b connected to the other one point of the three-point plate 60 move to the illuminating lamp 20a side as shown by the arrows in FIG. 8(b). Then, according to this movement of the second link 55a, the first link plate 62a is pressed and rotates counterclockwise in FIG. 5. Accordingly, the first tilt bar 64a fixed to the first link plate 62a also rotates counterclockwise, and the arm of the first tilt bar 64a moves to the back surface side of the illuminating portion 90. Accordingly, the tip side of the first tilt stay 66a is pulled via the first tilt link 56a and the elevation angle of the illuminating lamp 20a decreases from the angle θ. According to movement of the third link 55b, the second link plate 62b is pulled and rotates clockwise in FIG. 5. Accordingly, the second tilt bar 64b fixed to the second link plate 62b also rotates clockwise, and the arm of the second tilt bar 64b moves to the back surface side of the illuminating portion 90. Accordingly, the tip side of the second tilt stay 66b is pulled via the second tilt link 56b and the elevation angle of the illuminating lamp 20b decreases from the angle θ. At this time, the variation in elevation angle of the illuminating lamp 20b is equal to that of the illuminating lamp 20a. The illuminating arm portion 40′ also performs the above-described operation in the exact same manner, and accordingly, the elevation angles of the four illuminating lamps 20a, 20b, 20a′, and 20b′ of the illuminating portion 90 decrease in inverse proportion to an increase in elevation angle of the illuminating portion 90 (illuminating arm portions 40 and 40′).

Then, when the illuminating portion 90 reaches a predetermined elevation angle, the elevation angles of the illuminating lamps 20a to 20b′ become 0°, and the normal direction of the illuminating portion 90 substantially matches the irradiation directions of the illuminating lamps 20a to 20b′. It is preferable that the variation in elevation angle of the illuminating portion 90 (illuminating arm portions 40 and 40′) and the variation in elevation angle of the illuminating lamps 20a to 20b′ are set to be equal to each other. That is, they are preferably configured so that, in the case where the elevation angles θ of the illuminating lamps 20a to 20b′ at the directly downward illuminating position are 30°, the elevation angles of the illuminating lamps 20a to 20b′ become 0° when the illuminating arm portions 40 and 40′ pivot 30°.

Then, when the elevation angle of the illuminating portion 90 is further increased from the state shown in, for example, FIG. 6 where the elevation angles of the illuminating lamps 20a to 20b′ are 0°, the illuminating arm portions 40 and 40′ are caused to further pivot by the tilt motors. However, in this region, the arms 52a of the fixed link plates 52 are positioned at the sides opposite to the shaft pins 60a across the fixed shaft 82, and the displacement amounts of the three-point plates 60 with respect to pivoting of the illuminating arm portions 40 and 40′ are small. Therefore, the second links 55a and the third links 55b move little, and the elevation angles of the illuminating lamps 20a to 20b′ are maintained at nearly 0°. The range of variation of the elevation angle of the illuminating portion 90 is, for example, from the directly downward illuminating position (−90°) to approximately 130°, and a change in elevation angle beyond this range is limited by the above-described tilt limiting means.

When the elevation angle of the illuminating portion 90 is decreased from this state, the elevation angles of the illuminating lamps 20a to 20b′ are maintained at nearly 0° until the elevation angle of the illuminating portion 90 reaches a predetermined angle. Then, when the elevation angle of the illuminating portion 90 decreases from the predetermined angle, the amount of displacement of the three-point plate 60 increases, and the second link 55a and the third link 55b connected to the three-point plate 60 moves to the illuminating lamp 20b side. Due to this movement of the second link 55a, the first link plate 62a is pulled and rotates clockwise in FIG. 6. Accordingly, the first tilt bar 64a also rotates clockwise, and the arm of the first tilt bar 64a moves to the irradiating surface side of the illuminating portion 90. Accordingly, the tip side of the first tilt stay 66a is pressed via the first tilt link 56a, and the elevation angle of the illuminating lamp 20a increases from 0°. In addition, due to the movement of the third link 55b, the second link plate 62b is pressed and rotates counterclockwise in FIG. 6. Accordingly, the second tilt bar 64b also rotates counterclockwise, and the arm of the second tilt bar 64b moves to the irradiating surface side of the illuminating portion 90. Accordingly, the tip side of the second tilt stay 66b is pressed via the second tilt link 56b, and the elevation angle of the illuminating lamp 20b increases from 0°. The illuminating arm portion 40′ on the opposite side also performs the above-described operation in the exact same manner, and therefore, the elevation angles of the four illuminating lamps 20a, 20b, 20a′, and 20b′ of the illuminating portion 90 increase in inverse proportion to a decrease in elevation angle of the illuminating portion 90 (illuminating arm portions 40 and 40′). Then, the illuminating arm portions 40 and 40′ are stopped by the tilt limiting means when reaching the directly downward illuminating position shown in FIG. 5. At this time, the illuminating lamps 20a to 20b′ turn outward at an elevation angle θ with respect to the direction of the illuminating portion 90 and illuminate the surrounding of the illuminating portion 90.

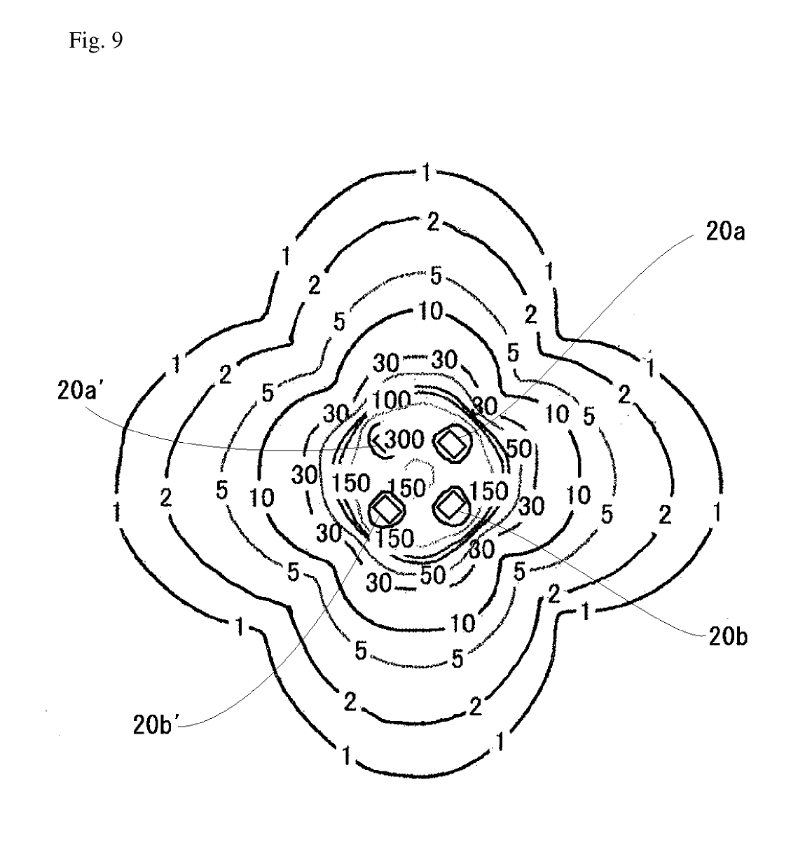

Each of the illuminating lamps 20a, 20b, 20a′, and 20b′ preferably includes, as shown in FIG. 1, an illuminating means 26 that illuminates the orthogonal direction, and a long lamp 24 the light of which is distributed in the lateral direction. With this configuration, as shown in the illuminance distribution simulation results in FIG. 9, the illuminating light from the illuminating portion 90 is distributed in a cross direction so that the central portion is superimposed, and the illuminance of the central portion can be increased at the time of distant irradiation. From the viewpoint of energy-saving, high-illuminance LEDs are preferably used as the illuminating means 26 and the long lamp 24.

As described above, in the lighting equipment 100 according to the present invention, when the illuminating portion 90 is at the directly downward illuminating position with an elevation angle of −90°, the illuminating lamps 20a, 20b, 20a′, and 20b′ automatically turn outward. Accordingly, a worksite can be widely illuminated. In the region in which the elevation angle of the illuminating portion 90 is a predetermined angle or more, the elevation angles of the illuminating lamps 20a to 20b′ are maintained at substantially 0° and the normal direction of the illuminating portion 90 substantially matches the irradiation directions of the illuminating lamps 20a to 20b′. Accordingly, the illuminating portion 90 can illuminate a distant object with a high illuminance. The elevation angles of the illuminating lamps 20a to 20b′ are varied and maintained by the link mechanisms 50 that vary the elevation angles of the illuminating lamps 20a to 20b′ according to rotations of the illuminating arm portions 40 and 40′, by mechanically interlocking with pivoting of the illuminating arm portions 40 and 40′. Accordingly, it becomes possible that the elevation angles of the illuminating lamps 20a to 20b′ are varied by only the tilt motors that cause the illuminating arm portions 40 and 40′ to pivot, and therefore, reduction in component cost and high operation stability are realized.

The shapes, dimensions, and configurations, etc., of the lighting equipment 100, the illuminating portion 90, the link mechanisms 50, and other components shown in this example are just examples, and the present invention can be modified and carried out without departing from the scope of the present invention.

### REFERENCE SIGNS LIST

14 Vertical fixed shaft
20a, 20b, 20a′, 20b′ Illuminating lamp
30 Base portion
40, 40′ Illuminating arm portion
40a, 40a′ One end face
40b, 40b′ Other end face
50 Link mechanism
52 Fixed link plate
52a Arm (of fixed link plate)
54 First link
55a Second link
55b Third link
56a First tilt link
56b Second tilt link
60 Three-point plate
62a First link plate
62b Second link plate
64a First tilt bar
64b Second tilt bar
66a First tilt stay
66b Second tilt stay
80 Rotary shaft portion
84 First rotary cylinder
84′ Second rotary cylinder
86 Connecting bar
82 Fixed shaft
90 Illuminating portion
100 Lighting equipment

1. Lighting equipment comprising an illuminating portion with four illuminating lamps the elevation angles of which are variable, wherein
when the illuminating portion is at an elevation angle of −90° at which the illuminating portion is directed directly downward, the illuminating lamps turn outward at a predetermined elevation angle θ with respect to the direction of the illuminating portion, and the elevation angles of the illuminating lamps increase or decrease in the range of θ to 0° in inverse proportion to an increase or decrease in elevation angle of the illuminating portion until the elevation angles of the illuminating portion reach a predetermined angle, and when the elevation angle of the illuminating portion is a predetermined angle or more, the elevation angles of the illuminating lamps are maintained at substantially 0° and the normal direction of the illuminating portion substantially matches the irradiation directions of the illuminating lamps.

2. The lighting equipment according to claim 1, wherein
the illuminating portion includes
a base portion rotatable in the horizontal direction,
illuminating arm portions that are mounted one each on the two side surfaces opposed to each other of the base portion, rotate coaxially right and left, and have both end faces being at approximately 45° to their long-side directions,
illuminating lamps mounted on both end faces of the illuminating arm portions so that their elevation angles are variable,
link mechanisms provided one each for the illuminating arm portions and vary the elevation angles of both illuminating lamps mounted on both end faces of the illuminating arm portions, wherein
the elevation angles of the illuminating lamps vary by mechanically interlocking with rotations of the illuminating arm portions.

3. The lighting equipment according to claim 2, wherein
one link mechanism includes
a rotary cylinder that rotates the illuminating arm portion,
a fixed shaft coaxial with the rotary cylinder,
a fixed link plate that is fixed to the fixed shaft and has an arm with a predetermined length,
a first link one end of which is connected to the arm of the fixed link plate,
a three-point plate one point of which is axially supported rotatably on the illuminating arm portion, to another point of which the other end of the first link is connected, and to the other one point of which a second link and a third link are connected,
a second link the other end of which extends toward one end face of the illuminating arm portion,
a third link the other end of which extends toward the other end face of the illuminating arm portion,
a first link plate that is mounted rotatably on the one end face, and connected to the other end of the second link,
a second link plate that is mounted rotatably on the other end face, and connected to the other end of the third link,
a first tilt bar that rotates together with the first link plate and has an arm with a predetermined length,
a second tilt bar that rotates together with the second link plate and has an arm with a predetermined length,
a first tilt link one end of which is connected to the arm of the first tilt bar,
a second tilt link one end of which is connected to the arm of the second tilt bar,
a first tilt stay that is fixed to the illuminating lamp mounted on one end face of the illuminating arm portion and bent into a substantially L-shape the tip end portion of which is connected to the other end of the first tilt link, and
a second tilt stay that is fixed to the illuminating lamp mounted on the other end face of the illuminating arm portion and bent into a substantially L-shape the tip end portion of which is connected to the other end of the second tilt link, wherein
according to rotations of the illuminating arm portions, the three-point plates rotate, the second links and the third links connected to the three-point plates move in substantially the same direction, the first link plates and the second link plates rotate respectively and push and pull the tip sides bent into substantially L-shapes of the first tilt stays and the second tilt stays to vary the elevation angles of the illuminating lamps on both end faces by equal amounts, respectively.

4. The lighting equipment according to claim 3, wherein
a vertical fixed shaft coaxial with the rotation axis in the horizontal direction of the base portion and the fixed shaft of the illuminating arm portions are joined in a T-shape, and
the rotary shaft portion of the illuminating arm portions includes a first rotary cylinder that is connected to one illuminating arm portion and inserted on the fixed shaft, a second rotary cylinder that is connected to the other illuminating arm portion and inserted on the fixed shaft, and a connecting bar that joins the first rotary cylinder and the second rotary cylinder, where
the connecting bar is fixed to circumferential surfaces of portions of the first rotary cylinder and the second rotary cylinder, and
further includes
a tilt limiting means that limits the rotation ranges of the first rotary cylinder and the second rotary cylinder to prevent the connecting bar from coming into contact with the vertical fixed shaft.
